(19) United States
(12) Patent Application Publication
(10) Pub. No.: US 2025/0306318 A1
(43) Pub. Date: Oct. 2, 2025

(54) EXPANDED BEAM FIBER ARRAY UNIT USING SPLICED PHOTONIC CRYSTAL AND MODE FIELD ADAPTER FIBERS

(71) Applicant: Intel Corporation, Santa Clara, CA (US)

(72) Inventors: Fan Fan, Chandler, AZ (US); Jianyong Mo, Chandler, AZ (US); Dekang Chen, Chandler, AZ (US); Feifei Cheng, Chandler, AZ (US); Liang Zhang, Chandler, AZ (US); Kumar Abhishek Singh, Phoenix, AZ (US); Saikumar Jayaraman, Chandler, AZ (US)

(73) Assignee: Intel Corporation, Santa Clara, CA (US)

(21) Appl. No.: 18/621,573

(22) Filed: Mar. 29, 2024

(51) Int. Cl. G02B 6/43; G02B 6/42

(52) U.S. Cl. CPC G02B 6/43; G02B 6/4214; G02B 6/4243; G02B 6/428

(57) ABSTRACT

Expanded beam optical fibers, and methods of forming the same, are disclosed herein. In one example, an optical fiber includes a first optical fiber section with a photonic crystal fiber, a second optical fiber section with a mode field adapter fiber, and a third optical fiber section with a single mode fiber. The first optical fiber section is coupled to the second optical fiber section, and the second optical fiber section is coupled to the third optical fiber section.

### GOVERNMENT RIGHTS

This Invention was made with Government support under Agreement No. N00164-19-9-0001, awarded by NSWC Crane Division. The Government has certain rights in the Invention.

### BACKGROUND

High-speed optical interconnects are crucial to meet the continuously increasing data rate demands of modern data centers and computing systems. For example, traditional computing components can be packaged with optical interfaces to enable them to communicate over high-speed optical interconnects rather than traditional electrical interconnects. An optical interface typically uses a photonic integrated circuit (PIC) to send and receive optical signals over optical fibers. This requires the PIC to be optically coupled to the fibers, either directly or indirectly, which in turn requires precise alignment between the PIC, the optical fibers, and/or any intervening components used to optically couple the PIC to the optical fibers. In many cases, however, it can be challenging to achieve the requisite degree of alignment due to process variations during manufacturing, particularly in view of the strict tolerance requirements for the alignment.

### BRIEF DESCRIPTION OF THE DRAWINGS

FIG. 1 illustrates an example of an optical interface with an expanded beam fiber array unit.

FIG. 2 illustrates an example of an expanded beam fiber array unit.

FIGS. 3A-C illustrate examples of photonic crystal fibers.

FIG. 4 illustrates an example of a mode field adapter fiber.

FIG. 5 illustrates an example process flow for forming an expanded beam fiber array unit.

FIGS. 6A-B illustrate an example embodiment of an optical package in accordance with certain embodiments.

FIG. 7 illustrates a top view of a wafer and dies that may be included in a microelectronic assembly.

FIG. 8 illustrates a cross-sectional side view of an integrated circuit device assembly.

FIG. 9 illustrates a block diagram of an example electronic device.

### DETAILED DESCRIPTION

As technology advances and applications become more reliant on artificial intelligence, high performance data centers, cloud computing, and 5G networks, enormous demands have been raised for ultra-high bandwidth, low data latency, and improved energy efficiency, resulting in an unprecedented expansion of on-board bandwidth density. Electrical interconnects are gradually approaching their limits, however, as any further increase in the data transmission speed of a copper interconnect typically causes it to become short range, lossy, and energy intensive. As a result, the industry has shifted its focus to optical interconnects, as their ultra-high bandwidth and low power consumption make them a promising alternative for overcoming the bandwidth bottleneck of traditional electrical interconnects.

Co-packaged optics (CPO), which refers to a technology for heterogenous integration of optical and electrical components in a single package (e.g., a processor with an optical interface), has become a key enabler on the roadmap to realizing on-board optical interconnects. One of the unique challenges of CPO is the stringent tolerance requirement in the assembly process to precisely align the waveguides of a photonic integrated circuit (PIC) with a fiber array unit (FAU), as extremely precise alignment is required to achieve optimal performance.

One approach to relaxing the strict alignment tolerance requirement is the use of beam expansion technologies to enlarge the beam diameter of light beams. For example, a microlens array can be attached to the PIC and/or the FAU to enlarge the light beams propagating between the PIC waveguides and the FAU fibers. However, the assembly process for an FAU with a microlens array—which may also be referred to as an expanded beam FAU—still has a strict alignment tolerance requirement due to the small mode field diameter of a standard single mode fiber, as the center of the microlens must be precisely aligned to the fiber core with a tolerance of no more than 1-2 μm. This alignment tolerance requirement increases the manufacturing complexity of an expanded beam FAU with a microlens array, and any misalignment beyond the required tolerance may negatively impact performance.

Accordingly, this disclosure presents embodiments of an expanded beam fiber array unit (FAU) with spliced photonic crystal fibers, mode field adapter (MFA) fibers, and standard single mode fibers (SMFs). For example, the expanded beam FAU may include an array of expanded beam fibers, each of which includes a photonic crystal (PhC) fiber spliced with an MFA fiber and a single mode fiber. In this manner, when light propagates through an expanded beam fiber, mode expansion will take place in the MFA fiber to enlarge the small mode field diameter (MFD) of the standard single mode fiber, and the resulting large mode area will be sustained in the photonic crystal fiber (which is optically coupled with the PIC waveguides).

These embodiments may provide various advantages. For example, the standard array of single mode fibers in a typical FAU is replaced with an array of spliced expanded beam fibers, thus relying on the mature process of assembling fibers into v-grooves to ensure pitch tolerance. The expanded beam fibers can be formed using a commercial fusion splicer to splice the photonic crystal, MFA, and single mode fibers with minimal splicing loss. In addition, the optical properties of the photonic crystal fibers can be designed to support single mode propagation with a large mode area, which is challenging with traditional fibers. Moreover, since beam expansion is provided by the expanded beam fibers, there is no need to attach a microlens array to the FAU, thus eliminating the high-precision alignment and attachment process required for a microlens array. Accordingly, the manufacturing complexity of the expanded beam FAU is significantly reduced, while the benefits of the relaxed alignment tolerance between the PIC and the FAU are maintained.

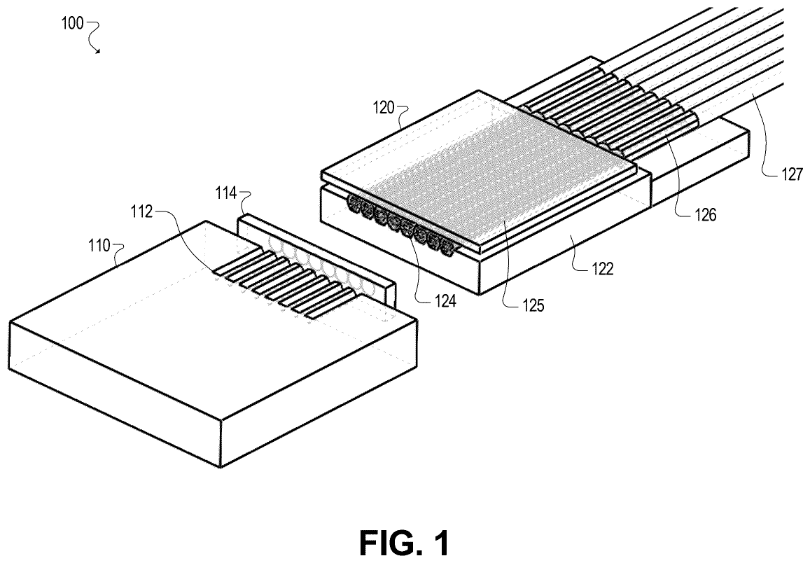

FIG. 1 illustrates an example of an optical interface 100 with an expanded beam fiber array unit (FAU) 120. In the illustrated embodiment, the optical interface 100 includes a photonic integrated circuit (PIC) 110 with multiple optical waveguides 112 and associated grooves, along with a microlens array 114 to perform beam expansion on light beams propagating to and from the waveguides 112. In various embodiments, the microlens array 114 may be fabricated and/or integrated with the PIC 110 in any suitable manner (independently fabricated and attached, 3D printed, lithographically fabricated using photolithography, gray-scale lithography, nanoimprint lithography, etc.). Moreover, the PIC 110 is designed to mate with an expanded beam FAU 120 to optically couple the waveguides 112 in the PIC 110 with the fibers 124 in the FAU 120. In the illustrated embodiment, the expanded beam FAU 120 includes an optical ferrule 122 attached to an array of expanded beam optical fibers 124, which are designed to perform beam and expansion and reduction on light beams propagating through the fibers 124. In this manner, the microlens array 114 on the PIC 110 and the expanded beam fibers 124 in the FAU 120 both leverage beam expansion to relax the strict tolerance requirements for alignment between the waveguides 112 in the PIC 110 and the fibers 124 in the FAU 120.

In the illustrated embodiment, for example, the expanded beam optical fibers 124 are designed to expand and contract light beams as they propagate through the fibers 124 in each direction. In particular, each expanded beam fiber 124 includes a photonic crystal (PhC) fiber 125, a mode field adapter (MFA) fiber 126, and a standard backend fiber 127 (e.g., standard single mode fiber or other long-haul fiber), which are spliced together to form a single expanded beam fiber 124, such that the MFA fiber 126 serves as a bridge between the photonic crystal fiber 125 and the standard backend fiber 127. In some embodiments, for example, a commercial fusion splicer may be used to splice the photonic crystal fiber 125 with one end of the MFA fiber 126 and splice the other end of the MFA fiber 126 with the standard backend fiber 127. In this manner, the MFA fiber 126 performs beam expansion and reduction on light beams traveling in each direction to gradually convert the mode field of the light beams between the respective mode field diameters (MFDs) of the standard backend fiber 127 and the photonic crystal fiber 125.

In some embodiments, for example, the standard backend fiber 127 may be a standard single mode fiber (SMF) (e.g., SMF-28) with a relatively small MFD (e.g., ˜9 microns (μm)), and the photonic crystal fiber 125 may be designed as a large mode area (LMA) single mode fiber with a much larger MFD than the standard single mode fiber 127. Moreover, the MFA fiber 126 may be designed to gradually convert the mode field of light beams between the respective MFDs of the standard single mode fiber 127 and the photonic crystal fiber 125. For example, the MFA fiber 126 may be an adiabatic taper fiber with a tapered core that gradually transitions in diameter, such that one end of the MFA fiber 126 has the same MFD as the single mode fiber 127 and the other end of the MFA fiber 126 has the same MFD as the photonic crystal fiber 125. In this manner, the tapered MFA fiber 126 can be used to convert light beams between the smaller MFD of the standard single mode fiber 127 and the larger MFD of the LMA single mode photonic crystal fiber 125.

Further, the optical ferrule 120 is attached to the photonic crystal fiber end 125 of the expanded beam fibers 124. In this manner, when the FAU 120 is coupled to the PIC 110, the photonic crystal fibers 124 in the FAU 120 are aligned with the optical waveguides 112 in the PIC 110, thus relaxing the alignment tolerance between the FAU fibers 124 and the PIC waveguides 112 due to the large mode area and expanded beams in the photonic crystal fibers 124.

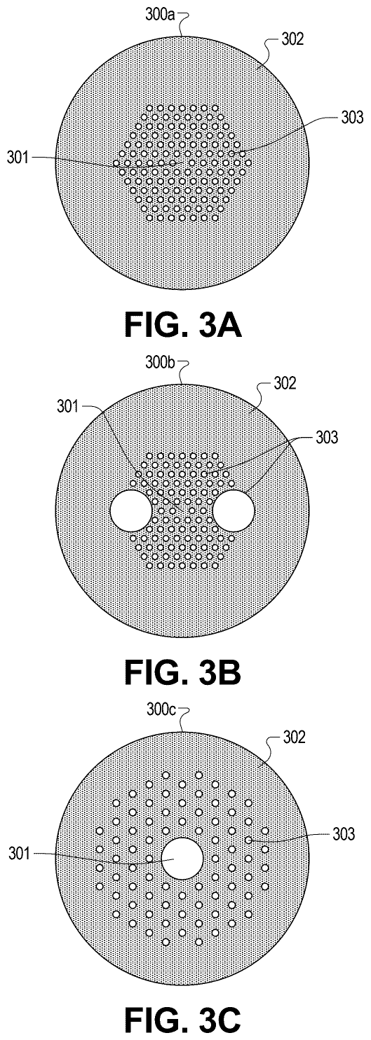

The use of photonic crystal fibers 125 in the spliced expanded beam fibers 124 provides various benefits. For example, as explained further in connection with FIGS. 3A-C, the periodic structure of a photonic crystal fiber enables its optical properties to be tuned by simply tailoring the design of the periodic structure, including the supported modes (e.g., single mode, multi-mode) and the effective mode area of the photonic crystal fiber. For example, the pattern or periodicity of the air hole cladding in a photonic crystal fiber can be designed to adjust the effective mode area of the fiber and/or create a photonic stop band to achieve a particular propagation mode (e.g., single mode propagation). In this manner, a photonic crystal fiber can be designed to support a fundamental or single mode of propagation with a large mode area, which is challenging to achieve with traditional fibers. For example, with traditional large mode area (LMA) fibers, higher order modes are likely to be generated, which means they are generally multi-mode fibers.

In this manner, the standard array of single mode fibers in a typical FAU is replaced with an array of spliced expanded beam fibers 124, thus relying on the mature process of assembling fibers into v-grooves to ensure pitch tolerance. Moreover, since beam expansion is provided by the expanded beam fibers 124, there is no need to attach a microlens array to the output end of the FAU 120, thus eliminating the high-precision alignment and attachment process required for a microlens array. Accordingly, the manufacturing complexity of expanded beam FAUs is significantly reduced, while the benefits of relaxed alignment tolerance between the PIC and FAU are maintained.

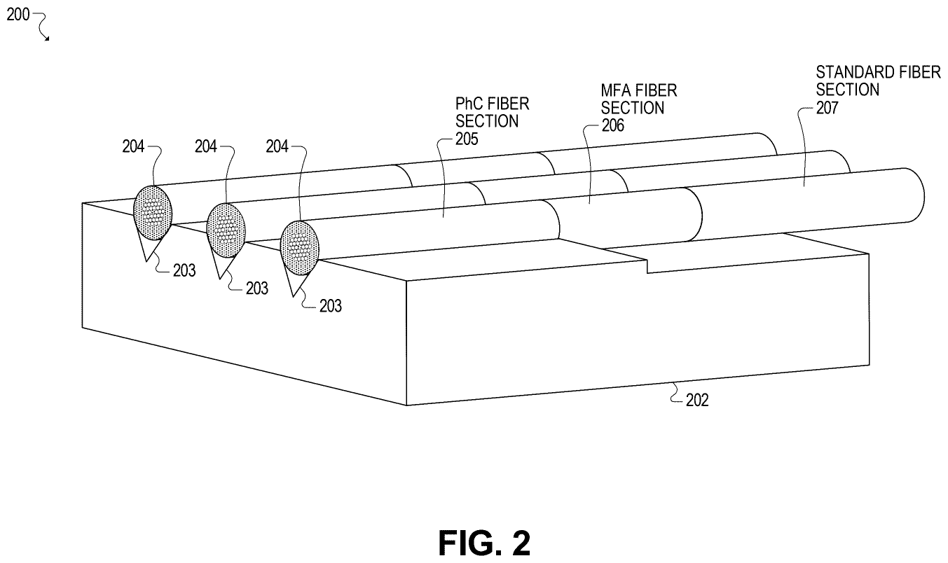

FIG. 2 illustrates an example of an expanded beam fiber array unit (FAU) 200 in accordance with certain embodiments. In some embodiments, expanded beam FAU 200 may be used to implement the expanded beam FAU 120 of optical interface 100.

In the illustrated embodiment, FAU 200 includes an optical ferrule 202 and an array of expanded beam optical fibers 204 attached to the ferrule 202. In particular, the ends of the expanded beam fibers 204 are inserted into v-grooves 203 on the optical ferrule 202. Further, each expanded beam fiber 204 includes multiple optical fiber sections 205, 206, 207 that respectively contain a photonic crystal (PhC) fiber 205, a mode field adapter (MFA) fiber 206, and a standard backend fiber 207, which are spliced together to form a single expanded beam fiber 204, where the MFA fiber section 206 is positioned between the photonic crystal fiber section 205 and the standard backend fiber section 207. For example, one end of the MFA fiber 206 may be spliced with the photonic crystal fiber 205, and the other end of the MFA fiber 206 may be spliced with the standard backend fiber 207.

In this manner, when light propagates through the expanded beam fiber 204, the MFA fiber section 206 converts the propagating light between the respective mode areas of the standard backend fiber section 207 and the photonic crystal fiber section 205 (e.g., by expanding and contracting the mode field diameter (MFD) of light propagating through the MFA fiber section 206).

In some embodiments, for example, the standard backend fiber 207 may be a standard single mode fiber (e.g., SMF-28), and the photonic crystal fiber 205 may be designed as a single mode fiber with a large mode area (LMA). In this manner, the MFA fiber section 206 converts light beams between the smaller MFD of the standard single mode fiber section 207 and the larger MFD of the LMA photonic crystal fiber section 205, thus adapting the respective mode fields of the standard single mode and photonic crystal fiber sections 207, 205.

As a result, when the FAU 200 is coupled to another optical component such as a photonic integrated circuit, the alignment tolerance is relaxed due to the beam expansion provided by the expanded beam FAU 200.

In various embodiments, the standard backend fiber 207 may be any type of fiber required by a particular application or use case, such as a standard single mode fiber (e.g., SMF-28) or another type of long-haul optical fiber, a multi-mode fiber, etc. Moreover, while the expanded beam FAU 200 is shown with three expanded beam fibers 204, the FAU 200 may include any number of expanded beam fibers 204 in actual embodiments. Further, while only one end of the FAU 200 is shown, the other end of the FAU 200 may be coupled to another component in actual embodiments, such as another optical ferrule/connector. In some embodiments, for example, the other end of the FAU 200 may be attached to a mechanical transfer (MT) connector (not shown), which may be used to mate with a standard MT connector on an optical cable or another optical component.

FIGS. 3A-C illustrate cross-section views of example photonic crystal fibers 300a-c. In some embodiments, photonic crystal fibers 300a-c may be used to implement the photonic crystal fibers 125, 205 in expanded beam FAUs 120, 200. In the illustrated example, each photonic crystal fiber 300a-c includes a core 301 and cladding 302 with a periodic pattern of air holes 303 in the cladding 302, which is designed to achieve a large mode area (LMA) for single mode propagation. In FIG. 3A, photonic crystal fiber 300a includes a solid core 301 with periodic air holes 303 patterned in the cladding 302 to achieve an LMA single mode fiber. In FIG. 3B, photonic crystal fiber 300b includes a solid core 301 with periodic air holes 303 patterned in the cladding 302 to achieve an LMA single mode fiber with polarization maintenance. In FIG. 3C, photonic crystal fiber 300c includes a hollow core 301 with periodic air holes 303 patterned in the cladding 302 to achieve an LMA single mode fiber with a photonic bandgap.

A photonic crystal (PhC) fiber, also known as a holey fiber or microstructured fiber, is an optical fiber whose waveguide properties are based on a pattern of small air holes or voids extending through the length of the fiber. These air holes form a periodic structure within the fiber, and the design of the periodic structure can be chosen to tailor the optical properties of the fiber, thus enabling precise control over the propagation of light within the fiber. Photonic crystal fibers are typically made of glass (e.g., silica glass) and have a solid or hollow core with periodic air hole cladding (e.g., an array of air holes surrounding the core).

Photonic crystal fibers can be designed to guide light using index-guiding principles (e.g., an index contrast between the core and cladding) and/or photonic bandgaps. For example, a photonic crystal fiber can be designed with a core that has a higher refractive index than the cladding (e.g., due to the periodicity of the air hole cladding), which guides light through total internal reflection. A photonic crystal fiber can also be designed to guide light using a photonic bandgap created by the periodic air hole cladding. In particular, the periodicity of the air holes can be designed to form a photonic bandgap, similar to the electronic bandgap found in semiconductor materials, which can prohibit or manipulate the transmission of certain wavelengths or frequencies of light.

The periodic structure of a photonic crystal fiber enables the optical properties of the fiber to be tuned for different applications, including the supported modes (e.g., single mode, multi-mode) and the effective mode area. For example, the pattern or periodicity of the air hole cladding may be designed to adjust the effective mode area of the fiber and/or create a photonic stop band or band gap to achieve a particular propagation mode (e.g., single mode propagation). In some embodiments, for example, a photonic crystal fiber may be designed with periodic cladding that achieves single mode propagation with a large mode area.

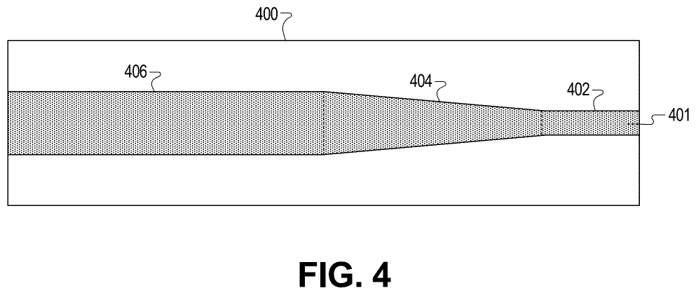

FIG. 4 illustrates a cross-section side view of an example mode field adapter (MFA) fiber 400. In some embodiments, MFA fiber 400 may be used to implement the MFA fibers 126, 206 in expanded beam FAUs 120, 200. In the illustrated embodiment, MFA fiber 400 includes a fiber core 401 with a diameter that varies in size across the length of the fiber. In particular, the fiber core 401 has multiple sections of varying diameter, including a small core section 402 with a relatively small diameter, a large core section 406 with a relatively large diameter, and a tapered core section 404 in the middle whose diameter gradually transitions between the respective diameters of the small core section 402 and the large core section 406. In this manner, MFA fiber 400 can be used to adapt the mode field of fibers with different mode areas or diameters.

In some embodiments, for example, the small core section 402 may have the mode field diameter (MFD) of a standard single mode fiber (e.g., SMF-28), the large core section 406 may have the MFD of a large mode area (LMA) fiber, and the tapered core section 404 may have an MFD that gradually transitions between the respective MFDs of a standard single mode fiber and an LMA fiber. Thus, the end of the small core section 402 of MFA fiber 400 may be spliced with a standard single mode fiber, and the end of the large core section 406 of MFA fiber 400 may be spliced with a large mode area (LMA) photonic crystal fiber, thus forming an expanded beam fiber with spliced photonic crystal, mode field adapter, and standard single mode fiber sections.

In particular, the mode area of an optical fiber refers to the effective cross-sectional area of the fiber over which light propagates for a particular optical mode. For single mode fibers (e.g., which support a single mode of propagation), the mode area is typically defined as the area within which a significant portion of the optical power is concentrated, which is often quantified using the mode field diameter (MFD). The mode field diameter (MFD) represents the diameter of the region in an optical fiber where the optical power is concentrated to a certain percentage of its maximum value (e.g., 1/e² of its peak intensity, or roughly 13.5%). In a single mode fiber, the MFD is typically slightly larger than the core of the fiber and extends into the cladding. Large mode area (LMA) fibers are designed to have a larger cross-sectional area for the optical mode of light propagation compared to conventional single mode fibers.

Thus, in some embodiments, an MFA fiber 400 may be used to optically couple fibers with different mode areas or MFDs, such as a standard single mode fiber and an LMA fiber. For example, the MFA fiber 400 may be an adiabatic taper fiber, which is a tapered fiber with a gradual change in diameter along its length. In some embodiments, the adiabatic taper fiber 400 may be formed by tapering down a large fiber core to match the size of a smaller core, or by expanding a small core (e.g., by heating) to match the size of a larger core. In this manner, the MFA fiber 400 can be used as an adapter to match the mode fields of fibers with different core sizes and/or MFDs, such as a standard single mode fiber and an LMA fiber.

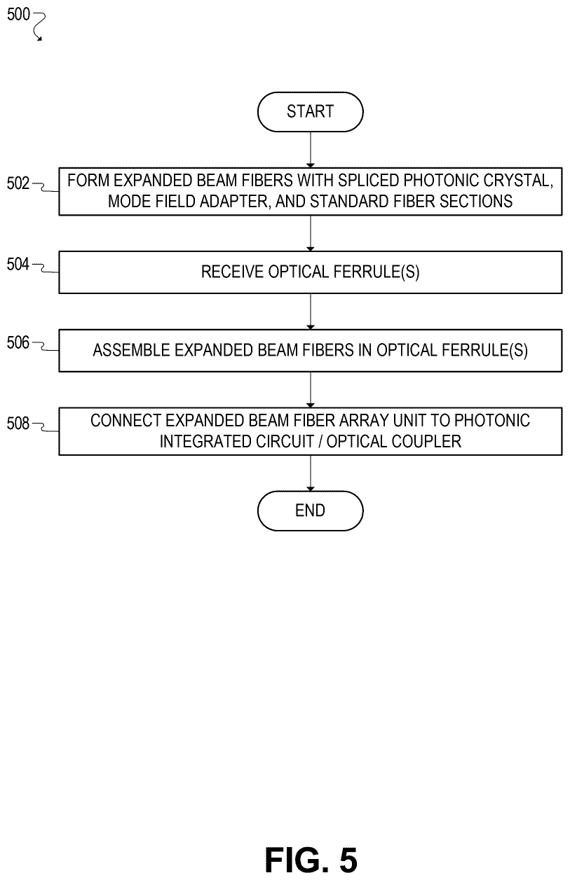

FIG. 5 illustrates an example process flow 500 for forming an expanded beam fiber array unit (FAU). In some embodiments, the illustrated process flow may be used to form the expanded beam FAU embodiments described throughout this disclosure (e.g., FAUs 120, 200). However, it will be appreciated in light of this disclosure that the illustrated process flow is only one example methodology for arriving at the example expanded beam FAUs disclosed herein.

The process flow begins at block 502 by forming one or more expanded beam optical fibers with spliced photonic crystal (PhC), mode field adapter (MFA), and standard backend fiber sections. Each expanded beam optical fiber may include a photonic crystal fiber, a mode field adapter fiber, and a standard backend fiber, which may be spliced together into a single optical fiber, where the mode field adapter fiber is positioned between the photonic crystal fiber and the standard backend fiber. In some embodiments, the respective optical fibers may be formed by splicing one end of the mode field adapter fiber with the photonic crystal fiber, and splicing the other end of the mode field adapter fiber with the standard backend fiber. In this manner, when light beams propagate through the optical fiber, the mode field adapter fiber converts the light beams between the respective mode areas of the standard backend fiber and the photonic crystal fiber (e.g., by expanding and contracting the diameter of the light beams).

In some embodiments, for example, the standard backend fiber may be a standard single mode fiber (e.g., SMF-28), and the photonic crystal fiber may be designed for single mode propagation but with a large mode area (LMA). In this manner, the mode field adapter fiber converts light beams between the smaller mode field diameter (MFD) of a standard single mode fiber and the large mode area of the photonic crystal fiber, thus performing mode expansion and reduction between the respective fiber sections.

The process flow then proceeds to block 504 to receive one or more optical ferrules for the expanded beam fibers. An optical ferrule, also referred to as an optical connector, is a component (e.g., made of glass, silicon, plastic) used to hold one of the ends of the expanded beam fibers and connect them to another optical component. For example, an optical ferrule may include an interface designed to hold one end of the expanded beam fibers securely in place with the requisite degree of alignment, such as holes or grooves (e.g., v-grooves) designed to hold an end of individual fibers. The optical ferrule may also include an interface designed to mate with another optical connector (e.g., an optical coupler on a photonic integrated circuit, another optical ferrule/connector on an optical cable). In this manner, the optical ferrule ensures precise alignment of the fiber cores when connected to another optical component, provides stability and prevents movement that may cause misalignment, and protects the ends of the fibers (e.g., from damage or contamination).

In some embodiments, optical ferrules may be attached to both ends of the expanded beam fibers. Moreover, the optical ferrules may have the same or different designs. For example, one of the optical ferrules may be designed to mate with an optical coupler on a PIC, while the other optical ferrule may be a standard mechanical transfer (MT) connector designed to mate with another MT connector (e.g., an MT connector on an optical cable).

The process flow then proceeds to block 506 to assemble the expanded beam fibers in the optical ferrule(s). In some embodiments, for example, each end of the expanded beam fibers may be inserted into grooves or holes on an optical ferrule and secured using an adhesive. For example, an end of an individual fiber may be assembled into an individual groove on an optical ferrule.

At this point, the expanded beam FAU may be complete. For example, the expanded beam FAU may include an array of expanded beam fibers with an optical ferrule/connector on one or both ends of the fibers.

The process flow may proceed to block 508 to connect the expanded beam FAU to one or more optical components, such as an optical coupler on a PIC, and/or another optical ferule/connector on an optical cable or other optical component. In some embodiments, for example, the optical ferrule on one end of the FAU may be plugged into an optical coupler on a PIC, and the optical ferrule on the other end of the FAU may be plugged into a standard optical cable (e.g., an MT optical cable).

At this point, the process flow may be complete. In some embodiments, however, the process flow may restart and/or certain blocks may be repeated. For example, in some embodiments, the process flow may restart at block 502 to continue forming expanded beam FAUs.

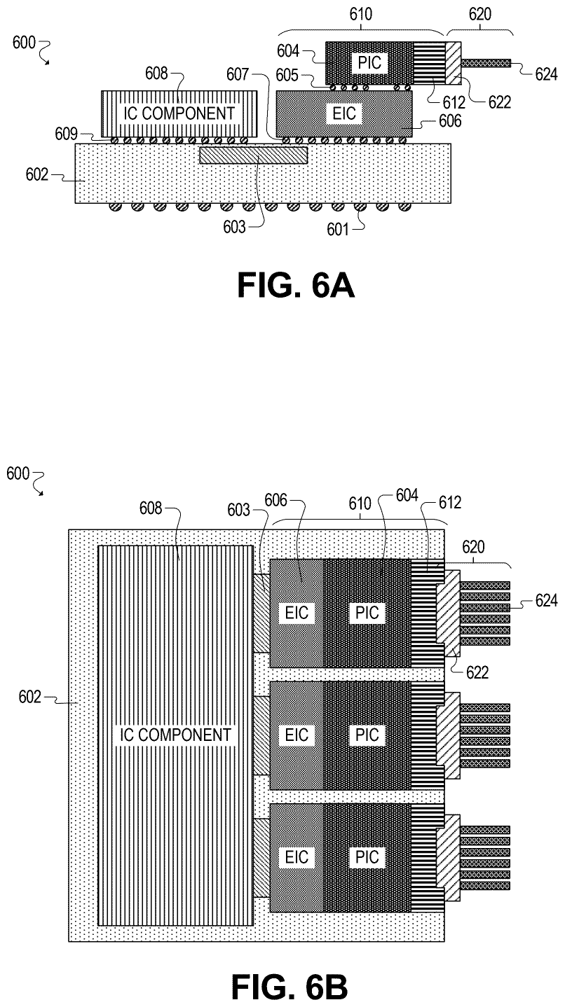

FIGS. 6A-B illustrate cross-section and plan views of an example optical package 600 in accordance with certain embodiments. In the illustrated embodiment, optical package 600 is an integrated circuit (IC) package with co-packaged optics. In particular, optical package 600 includes an IC component 608 packaged with optical interfaces 610 and associated fiber array units (FAUs) 620 for optical communication and input/output (I/O). In some embodiments, the FAUs 620 may be implemented using any of the embodiments of optical fibers and/or FAUs described herein (e.g., fibers 124, 204, 300a-c, 400, FAUs 120, 200).

In the illustrated embodiment, optical package 600 includes an IC component 608 (e.g., an XPU) and multiple optical interfaces 610 on a package substrate 602, along with optical cables or fiber array units (FAUs) 620 plugged into the respective optical interfaces 610.

Each optical interface 610 includes an optical coupler 612, a photonic integrated circuit (PIC) 604, and an electronic integrated circuit (EIC) 606. The EICs 606 are attached to the top surface of the package substrate 602, the PICs 604 are attached to the top surface of corresponding EICs 606, and the optical couplers 612 are attached to the side/edge of corresponding PICs 604. In various embodiments, however, the PICs 604, EICs 606, and other optical/electrical components may be integrated, packaged, and/or arranged in any suitable manner, including, without limitation, PIC 604 on EIC 606, EIC 606 on PIC 604, combined EIC 606 and PIC 604 (e.g., integrated monolithically on the same die), etc.

The EICs 606 are used to control the PICs 604 and may include components such as drivers, transimpedance amplifiers (TIA), carrier phase recovery (CPR), clock/data recovery (CDR), serializer/deserializer, equalizer, sampler, and so forth. The EICs 606 are electrically coupled to the package substrate 602 via conductive contacts 607 (e.g., bumps/micro-bumps), and the EICs 606 are further electrically coupled to the IC component 608 via the bridges 603 embedded in the substrate 602.

The PICs 604 are used to send and/or receive optical signals via fiber arrays 624 (e.g., on behalf of the IC component 608). Each PIC 604 includes components and circuitry for sending and receiving optical signals, such as laser diodes (LD)/modulators (LD-MOD) (e.g., for transmitting optical signals), photodiodes (PD) (e.g., for receiving optical signals), waveguides, optical couplers, collimation/refocusing lenses, reflection mirrors, and so forth. Each PIC 604 is controlled by an associated EIC 606 and is electrically coupled to the top surface of the EIC 606 via conductive contacts 605 (e.g., bumps/micro-bumps).

An optical coupler 612 is also attached to each PIC 604. The optical coupler 612, which may also be referred to as an optical interposer, is used to optically couple, or route optical signals (e.g., light) between, the PIC 604 and another optical component, such as an optical cable 620. In some embodiments, the optical coupler 612 may include an interface attached to the PIC 604, an interface to mate with an optical ferrule 622 on an optical cable 620, and waveguides to route optical signals between the respective interfaces. The optical coupler 612 may optionally include various other optical and/or electrical routing features, such as through-glass vias, reflection mirrors, and so forth.

Each optical cable 620 includes an optical ferrule 622 attached to a bundle of optical (e.g., glass) fibers 624, which may be referred to as a fiber array or fiber array unit (FAU). The optical ferrule 622 may be used to optically couple, or route optical signals between, the fiber array 624 and an optical coupler 612. In some embodiments, the optical ferrule 622 may include an interface attached to the fiber array 624 (e.g., holes in the ferrule 622 in which the fibers 624 are inserted), an interface to mate with an optical coupler 612, and/or waveguides to route optical signals between the respective interfaces.

In some embodiments, for example, the optical coupler 612 and the optical ferrule 622 may include complementary pluggable interfaces that are designed to mate. For example, the optical coupler 612 may include an optical socket and the optical ferrule 622 may include a corresponding optical plug designed to mate with the optical socket (or vice versa). In this manner, each PIC 604 is optically coupled to an associated fiber array 624 via the mated optical coupler 612 and optical ferrule 622.

Further, in some embodiments, the optical coupler 612 and optical ferrule 622 may include complementary mating and alignment features (e.g., mating protrusions and receptacles, pins and pin holes, grooves) to ensure they mate with each other with the requisite degree of alignment, as the waveguides in the ferrule 622 must be precisely aligned with the waveguides in the optical coupler 612. For example, when the optical ferrule 622 is plugged into to the optical coupler 612, their respective mating and alignment features engage, which causes the waveguides in the ferrule 622 to precisely align with the waveguides in the optical coupler 612. In this manner, the PIC 604 is optically coupled to the fiber array 624 via the mated optical coupler 612 and ferrule 622, which enables the PIC 604 to send and receive optical signals via the fiber array 624.

In some embodiments, the optical coupler 612 and/or optical ferrule 622 may be made of glass, and their respective features (e.g., interfaces, mating/alignment features, waveguides) may be patterned in the glass (e.g., using laser etching techniques).

The fiber array 624 may be used to send and receive optical signals to and from other components (not shown). For example, the other end of the fiber array 624 may be optically coupled to other components (not shown), such as other computing components that are part of the same device or system as optical package 600 (e.g., processors, XPUs, network interface controllers (NICs), storage, memory, I/O devices, other integrated circuits), an external device or system, a switch, another optical connector (e.g., a connector similar to optical coupler 612 and/or optical ferrule 622, a standard optical connector such as a mechanical transfer (MT) or multi-fiber push on (MPO) connector), a fiber cable, and so forth.

The IC component 608 is attached to the top surface of the package substrate 602. Moreover, the IC component 608 is electrically coupled to the package substrate 602 via conductive contacts 609 (e.g., bumps/micro-bumps), which serve as the first level interconnect (FLI) for the IC component 608. The IC component 608 is also electrically coupled to the EICs 606 via bridges 603 embedded in the substrate 602 (e.g., embedded multi-die interconnect bridges (EMIB)). In this manner, the IC component 608 can use the EICs 606 to communicate over the respective optical interfaces 610 (e.g., via PICs 604 and FAUs 620).

The IC component 608 may include any integrated circuit (IC) (e.g., IC die, IC package) that uses optical interfaces 610 for optical communication and/or I/O. The IC component 608 may include any type or combination of circuitry, such as processing circuitry, memory circuitry, storage circuitry, and/or communication circuitry. For example, the IC component 608 may include, without limitation, a microcontroller, a microprocessor, an XPU, a central processing unit (CPU), a graphics processing unit (GPU), a vision processing unit (VPU), a tensor processing unit (TPU), an application-specific integrated circuit (ASIC), a field-programmable gate array (FPGA), a switch, a network interface controller (NIC), a memory device (e.g., memory, memory controller), and/or a persistent storage device (e.g., hard disk drive (HDD), solid state drive (SSD)), among other examples.

The package substrate 602 includes conductive contacts 601 (e.g., balls, pads) on the bottom surface, which serve as the second level interconnect (SLI) to a next-level component, such as a printed circuit board (e.g., a motherboard) and/or another integrated circuit package (not shown). The package substrate 602 also includes conductive traces (not shown) patterned in the substrate to provide power and input/output (I/O) to the respective components in package 600 (e.g., IC component 608, EICs 606, PICs 604).

In some embodiments, the optical package 600 may be part of an electronic device or system, such as a mobile device, a wearable device, a computer, a server, a video playback device, a video game console, a display device, a camera, or an appliance. For example, the optical package 600 and various other electronic components may be electrically coupled to a circuit board within the electronic device.

It should be appreciated that optical package 600 is merely presented as an example. In other embodiments, certain components may be omitted, added, rearranged, modified, or combined. For example, embodiments may include any number, combination, or arrangement of PICs and EICs (e.g., for higher bandwidth and/or redundancy), optical connectors, optical couplers, optical ferrules, optical interposers, fibers, bridges, IC components (e.g., XPUs or other computing components), substrates, surface cavities in the substrate, conductive contacts, conductive traces, vias, integrated circuit packages, and so forth.

### Example Integrated Circuit Embodiments

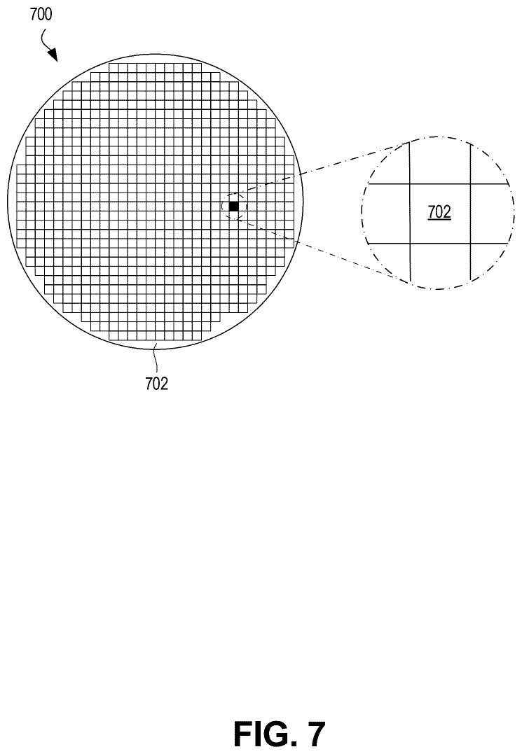

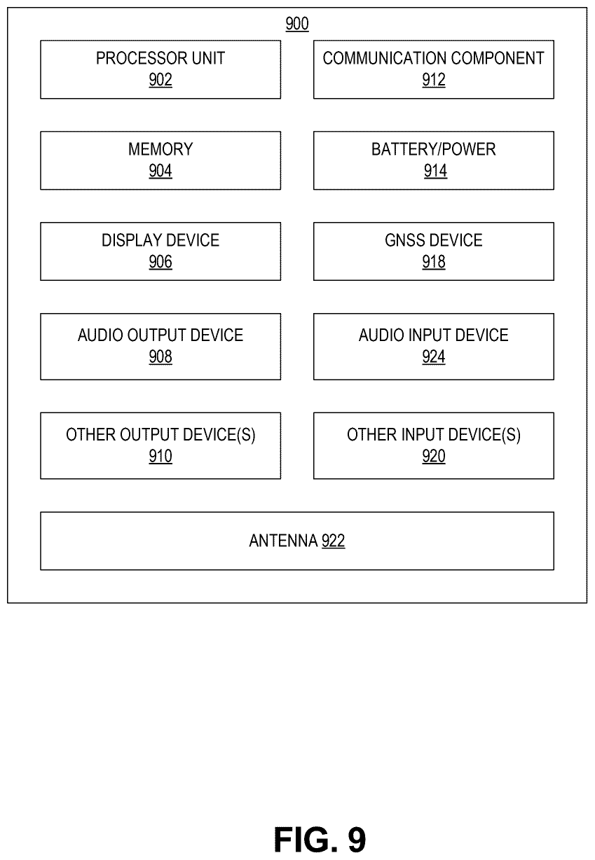

FIG. 7 is a top view of a wafer 700 and dies 702 that may be included in any of the embodiments disclosed herein. The wafer 700 may be composed of semiconductor material and may include one or more dies 702 having integrated circuit structures formed on a surface of the wafer 700. The individual dies 702 may be a repeating unit of an integrated circuit product that includes any suitable integrated circuit (e.g., PIC 110, 604, EIC 606, IC component 608). After the fabrication of the semiconductor product is complete, the wafer 700 may undergo a singulation process in which the dies 702 are separated from one another to provide discrete “chips” of the integrated circuit product. The die 702 may be any of the dies disclosed herein. The die 702 may include one or more transistors, supporting circuitry to route electrical signals to the transistors, passive components (e.g., signal traces, resistors, capacitors, or inductors), and/or any other integrated circuit components. In some embodiments, the wafer 700 or the die 702 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 702. For example, a memory array formed by multiple memory devices may be formed on a same die 702 as a processor unit (e.g., the processor unit 902 of FIG. 9) or other logic that is configured to store information in the memory devices or execute instructions stored in the memory array. Various ones of the microelectronic assemblies disclosed herein may be manufactured using a die-to-wafer assembly technique in which some dies are attached to a wafer 700 that include others of the dies, and the wafer 700 is subsequently singulated.

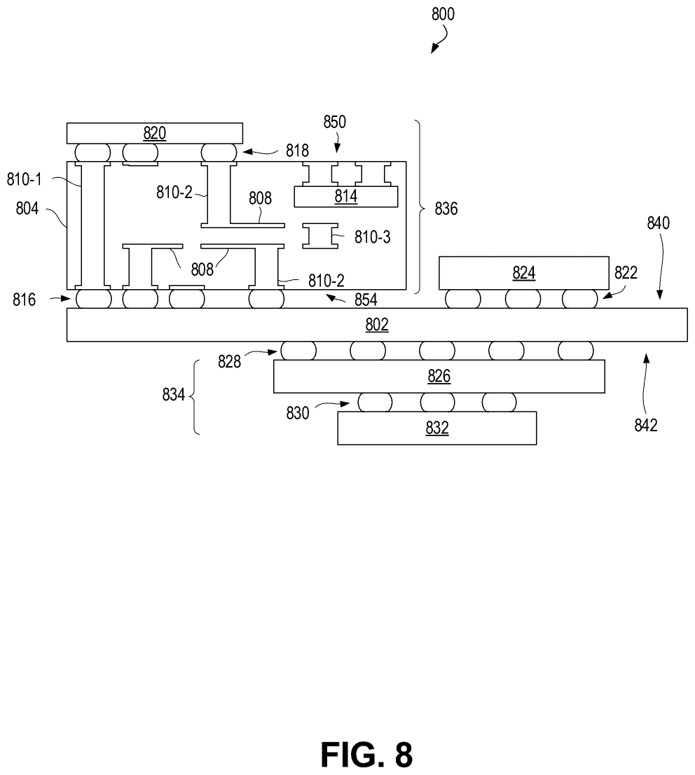

FIG. 8 is a cross-sectional side view of an integrated circuit device assembly 800 that may include any of the embodiments disclosed herein (e.g., fiber array units (FAUs) 120, 200, photonic integrated circuits (PICs) 110, 604, optical interfaces 100, 610, optical package 600). In some embodiments, the integrated circuit device assembly 800 may be a microelectronic assembly. The integrated circuit device assembly 800 includes a number of components disposed on a circuit board 802 (which may be a motherboard, system board, mainboard, etc.). The integrated circuit device assembly 800 includes components disposed on a first face 840 of the circuit board 802 and an opposing second face 842 of the circuit board 802; generally, components may be disposed on one or both faces 840 and 842. Any of the integrated circuit components discussed below with reference to the integrated circuit device assembly 800 may take the form of any suitable ones of the embodiments of the microelectronic assemblies disclosed herein.

In some embodiments, the circuit board 802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 802. In other embodiments, the circuit board 802 may be a non-PCB substrate. The integrated circuit device assembly 800 illustrated in FIG. 8 includes a package-on-interposer structure 836 coupled to the first face 840 of the circuit board 802 by coupling components 816. The coupling components 816 may electrically and mechanically couple the package-on-interposer structure 836 to the circuit board 802, and may include solder balls (as shown in FIG. 8), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 816 may serve as the coupling components illustrated or described for any of the substrate assembly or substrate assembly components described herein, as appropriate.

The package-on-interposer structure 836 may include an integrated circuit component 820 coupled to an interposer 804 by coupling components 818. The coupling components 818 may take any suitable form for the application, such as the forms discussed above with reference to the coupling components 816. Although a single integrated circuit component 820 is shown in FIG. 8, multiple integrated circuit components may be coupled to the interposer 804; indeed, additional interposers may be coupled to the interposer 804. The interposer 804 may provide an intervening substrate used to bridge the circuit board 802 and the integrated circuit component 820.

The integrated circuit component 820 may be a packaged or unpacked integrated circuit product that includes one or more integrated circuit dies (e.g., die 702, PIC 110, 604, EIC 606, IC component 608) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 820, a single monolithic integrated circuit die comprises solder bumps attached to contacts on the die. The solder bumps allow the die to be directly attached to the interposer 804. The integrated circuit component 820 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 820 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 820 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 804 may spread connections to a wider pitch or reroute a connection to a different connection. For example, the interposer 804 may couple the integrated circuit component 820 to a set of ball grid array (BGA) conductive contacts of the coupling components 816 for coupling to the circuit board 802. In the embodiment illustrated in FIG. 8, the integrated circuit component 820 and the circuit board 802 are attached to opposing sides of the interposer 804; in other embodiments, the integrated circuit component 820 and the circuit board 802 may be attached to a same side of the interposer 804. In some embodiments, three or more components may be interconnected by way of the interposer 804.

In some embodiments, the interposer 804 may be formed as a PCB, including multiple metal layers separated from one another by layers of dielectric material and interconnected by electrically conductive vias. In some embodiments, the interposer 804 may be formed of an epoxy resin, a fiberglass-reinforced epoxy resin, an epoxy resin with inorganic fillers, a ceramic material, or a polymer material such as polyimide. In some embodiments, the interposer 804 may be formed of alternate rigid or flexible materials that may include the same materials described above for use in a semiconductor substrate, such as silicon, germanium, and other group III-V and group IV materials. The interposer 804 may include metal interconnects 808 and vias 810, including but not limited to through hole vias 810-1 (that extend from a first face 850 of the interposer 804 to a second face 854 of the interposer 804), blind vias 810-2 (that extend from the first or second faces 850 or 854 of the interposer 804 to an internal metal layer), and buried vias 810-3 (that connect internal metal layers).

In some embodiments, the interposer 804 can comprise a silicon interposer. Through silicon vias (TSV) extending through the silicon interposer can connect connections on a first face of a silicon interposer to an opposing second face of the silicon interposer. In some embodiments, an interposer 804 comprising a silicon interposer can further comprise one or more routing layers to route connections on a first face of the interposer 804 to an opposing second face of the interposer 804.

The interposer 804 may further include embedded devices 814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 804. The package-on-interposer structure 836 may take the form of any of the package-on-interposer structures known in the art. In embodiments where the interposer is a non-printed circuit board

The integrated circuit device assembly 800 may include an integrated circuit component 824 coupled to the first face 840 of the circuit board 802 by coupling components 822. The coupling components 822 may take the form of any of the embodiments discussed above with reference to the coupling components 816, and the integrated circuit component 824 may take the form of any of the embodiments discussed above with reference to the integrated circuit component 820.

The integrated circuit device assembly 800 illustrated in FIG. 8 includes a package-on-package structure 834 coupled to the second face 842 of the circuit board 802 by coupling components 828. The package-on-package structure 834 may include an integrated circuit component 826 and an integrated circuit component 832 coupled together by coupling components 830 such that the integrated circuit component 826 is disposed between the circuit board 802 and the integrated circuit component 832. The coupling components 828 and 830 may take the form of any of the embodiments of the coupling components 816 discussed above, and the integrated circuit components 826 and 832 may take the form of any of the embodiments of the integrated circuit component 820 discussed above. The package-on-package structure 834 may be configured in accordance with any of the package-on-package structures known in the art.

FIG. 9 is a block diagram of an example electronic device 900 that may include one or more of the embodiments disclosed herein. For example, any suitable ones of the components of the electronic device 900 may include one or more of the optical components (e.g., FAUs 120, 200, PICs 110, 604, optical interfaces 100, 610, optical package 600), integrated circuit device assemblies 800, integrated circuit components 820, or integrated circuit dies 702 disclosed herein. In some embodiments, for example, the electronic device 900 and/or its respective components (e.g., processor units 902, input/output (I/O) devices 910, 920, communication components 912, memory 904) may include an optical interface with an associated fiber array unit for optical communication according to any of the embodiments described herein. A number of components are illustrated in FIG. 9 as included in the electronic device 900, but any one or more of these components may be omitted or duplicated, as suitable for the application. In some embodiments, some or all of the components included in the electronic device 900 may be attached to one or more motherboards mainboards, or system boards. In some embodiments, one or more of these components are fabricated onto a single system-on-a-chip (SoC) die.

Additionally, in various embodiments, the electronic device 900 may not include one or more of the components illustrated in FIG. 9, but the electronic device 900 may include interface circuitry for coupling to the one or more components. For example, the electronic device 900 may not include a display device 906, but may include display device interface circuitry (e.g., a connector and driver circuitry) to which a display device 906 may be coupled. In another set of examples, the electronic device 900 may not include an audio input device 924 or an audio output device 908, but may include audio input or output device interface circuitry (e.g., connectors and supporting circuitry) to which an audio input device 924 or audio output device 908 may be coupled.

The electronic device 900 may include one or more processor units 902 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electronic device 900 may include a memory 904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 904 may include memory that is located on the same integrated circuit die as the processor unit 902. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electronic device 900 can comprise one or more processor units 902 that are heterogeneous or asymmetric to another processor unit 902 in the electronic device 900. There can be a variety of differences between the processing units 902 in a system in terms of a spectrum of metrics of merit including architectural, microarchitectural, thermal, power consumption characteristics, and the like. These differences can effectively manifest themselves as asymmetry and heterogeneity among the processor units 902 in the electronic device 900.

In some embodiments, the electronic device 900 may include a communication component 912 (e.g., one or more communication components). For example, the communication component 912 can manage wireless communications for the transfer of data to and from the electronic device 900. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 912 may operate in accordance with other wireless protocols in other embodiments. The electronic device 900 may include an antenna 922 to facilitate wireless communications and/or to receive other wireless communications (such as AM or FM radio transmissions).

In some embodiments, the communication component 912 may manage wired communications, such as electrical, optical, or any other suitable communication protocols (e.g., IEEE 802.3 Ethernet standards). As noted above, the communication component 912 may include multiple communication components. For instance, a first communication component 912 may be dedicated to shorter-range wireless communications such as Wi-Fi or Bluetooth, and a second communication component 912 may be dedicated to longer-range wireless communications such as global positioning system (GPS), EDGE, GPRS, CDMA, WiMAX, LTE, EV-DO, or others. In some embodiments, a first communication component 912 may be dedicated to wireless communications, and a second communication component 912 may be dedicated to wired communications.

The electronic device 900 may include battery/power circuitry 914. The battery/power circuitry 914 may include one or more energy storage devices (e.g., batteries or capacitors) and/or circuitry for coupling components of the electronic device 900 to an energy source separate from the electronic device 900 (e.g., AC line power).

The electronic device 900 may include a display device 906 (or corresponding interface circuitry, as discussed above). The display device 906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electronic device 900 may include an audio output device 908 (or corresponding interface circuitry, as discussed above). The audio output device 908 may include any embedded or wired or wirelessly connected external device that generates an audible indicator, such speakers, headsets, or earbuds.

The electronic device 900 may include an audio input device 924 (or corresponding interface circuitry, as discussed above). The audio input device 924 may include any embedded or wired or wirelessly connected device that generates a signal representative of a sound, such as microphones, microphone arrays, or digital instruments (e.g., instruments having a musical instrument digital interface (MIDI) output). The electronic device 900 may include a Global Navigation Satellite System (GNSS) device 918 (or corresponding interface circuitry, as discussed above), such as a Global Positioning System (GPS) device. The GNSS device 918 may be in communication with a satellite-based system and may determine a geolocation of the electronic device 900 based on information received from one or more GNSS satellites, as known in the art.

The electronic device 900 may include other output device(s) 910 (or corresponding interface circuitry, as discussed above). Examples of the other output device(s) 910 may include an audio codec, a video codec, a printer, a wired or wireless transmitter for providing information to other devices, or an additional storage device.

The electronic device 900 may include other input device(s) 920 (or corresponding interface circuitry, as discussed above). Examples of the other input device(s) 920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a display device (e.g., monitor, television), a set-top box, an entertainment control unit, a video game console, a video playback device, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 900 may be any other electronic device that processes data. In some embodiments, the electrical device 900 may comprise multiple discrete physical components. Given the range of devices that the electrical device 900 can be manifested as in various embodiments, in some embodiments, the electrical device 900 can be referred to as a computing device or a computing system.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Further, it should be understood that the various embodiments shown in the figures are illustrative representations and are not necessarily drawn to scale.

Moreover, the illustrations and/or descriptions of various embodiments may be simplified or approximated for ease of understanding, and as a result, they may not necessarily reflect the level of precision nor variation that may be present in actual embodiments. For example, while some figures generally indicate straight lines, right angles, and smooth surfaces, actual implementations of the disclosed embodiments may have less than perfect straight lines and right angles, and some features may have surface topography or otherwise be non-smooth, given real-world limitations of fabrication processes. Similarly, illustrations and/or descriptions of how components are arranged may be simplified or approximated for ease of understanding and may vary by some margin of error in actual embodiments (e.g., due to fabrication processes, etc.).

Unless otherwise specified, the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

The terms “substantially,” “close,” “approximately,” “near,” and “about,” generally refer to being within +/−10% of a target value (unless otherwise specified). Similarly, terms describing spatial relationships, such as “perpendicular,” “orthogonal,” or “coplanar,” may refer to being substantially within the described spatial relationships (e.g., within +/−10 degrees of orthogonality).

Certain terminology may also be used in the foregoing description for the purpose of reference only, and thus are not intended to be limiting. For example, terms such as “upper,” “lower,” “above,” “below,” “bottom,” and “top” refer to directions in the drawings to which reference is made. Terms such as “front,” “back,” “rear,” and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

The terms “over”, “between”, “adjacent”, “to”, and “on” as used herein may refer to a relative position of one layer or component with respect to other layers or components. For example, one layer “over” or “on” another layer, “adjacent” to another layer, or bonded “to” another layer may be directly in contact with the other layer or may have one or more intervening layers. One layer “between” layers may be directly in contact with the layers or may have one or more intervening layers.

The meaning of “a,” “an,” and “the” include plural references. The meaning of “in” includes “in” and “on.”

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

The term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials.

The term “coreless” generally refers to a substrate of an integrated circuit package having no core. The lack of a core allows for higher-density package architectures, as the through-vias have relatively large dimensions and pitch compared to high-density interconnects.

The term “land side”, if used herein, generally refers to the side of the substrate of the integrated circuit package closest to the plane of attachment to a printed circuit board, motherboard, or other package. This is in contrast to the term “die side”, which is the side of the substrate of the integrated circuit package to which the die or dice are attached.

The term “dielectric” generally refers to any number of non-electrically conductive materials that make up the structure of a package substrate. For purposes of this disclosure, dielectric material may be incorporated into an integrated circuit package as layers of laminate film or as a resin molded over integrated circuit dice mounted on the substrate.

The term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

The term “bond pad” generally refers to metallization structures that terminate integrated traces and vias in integrated circuit packages and dies. The term “solder pad” may be occasionally substituted for “bond pad” and carries the same meaning.

The term “solder bump” generally refers to a solder layer formed on a bond pad. The solder layer typically has a round shape, hence the term “solder bump”.

The term “substrate” generally refers to a planar platform comprising dielectric and/or metallization structures. The substrate may mechanically support and electrically couple one or more IC dies on a single platform, with encapsulation of the one or more IC dies by a moldable dielectric material. The substrate generally comprises solder bumps as bonding interconnects on both sides. One side of the substrate, generally referred to as the “die side”, may comprise solder bumps for chip or die bonding. The opposite side of the substrate, generally referred to as the “land side”, may comprise solder bumps for bonding the package to a printed circuit board.

The term “assembly” generally refers to a grouping of parts into a single functional unit. The parts may be separate and are mechanically assembled into a functional unit, where the parts may be removable. In another instance, the parts may be permanently bonded together. In some instances, the parts are integrated together.

The terms “coupled” or “connected” means a direct or indirect connection, such as a direct electrical, mechanical, magnetic or fluidic connection between the things that are connected or an indirect connection, through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an optical fiber, comprising: a first optical fiber section, wherein the first optical fiber section comprises a photonic crystal fiber; a second optical fiber section coupled to the first optical fiber section, wherein the second optical fiber section comprises a mode field adapter fiber; and a third optical fiber section coupled to the second optical fiber section, wherein the third optical fiber section comprises a single mode fiber.

Example 2 includes the optical fiber of Example 1, wherein the second optical fiber section is between the first optical fiber section and the third optical fiber section.

Example 3 includes the optical fiber of any of Examples 1-2, wherein the photonic crystal fiber has a large mode area and is configured for single mode propagation.

Example 4 includes the optical fiber of Example 3, wherein the photonic crystal fiber comprises a pattern of holes, wherein the pattern of holes corresponds to a particular photonic stop band for single mode propagation.

Example 5 includes the optical fiber of any of Examples 1-4, wherein a core of the mode field adapter fiber is tapered, wherein a first end of the mode field adapter fiber has a first mode field diameter (MFD), and wherein a second end of the mode field adapter fiber has a second MFD, wherein the first MFD is larger than the second MFD.

Example 6 includes the optical fiber of Example 5, wherein the first end of the mode field adapter fiber has a large mode area.

Example 7 includes the optical fiber of any of Examples 5-6, wherein the first end of the mode field adapter fiber is coupled to the photonic crystal fiber, and wherein the second end of the mode field adapter fiber is coupled to the single mode fiber.

Example 8 includes the optical fiber of any of Examples 1-7, wherein the mode field adapter fiber is an adiabatic taper fiber.

Example 9 includes the optical fiber of any of Examples 1-8, wherein the single mode fiber is a SMF-28 fiber.

Example 10 includes the optical fiber of any of Examples 1-9, wherein the optical fiber is an expanded beam optical fiber.

Example 11 includes a fiber array unit, comprising: a ferrule; and a plurality of optical fibers coupled to the ferrule, wherein individual optical fibers comprise a photonic crystal fiber, a mode field adapter fiber, and a single mode fiber, wherein: the photonic crystal fiber, the mode field adapter fiber, and the single mode fiber are coupled; and the mode field adapter fiber is between the photonic crystal fiber and the single mode fiber.

Example 12 includes the fiber array unit of Example 11, wherein the ferrule comprises a plurality of grooves, wherein individual optical fibers are coupled to individual grooves.

Example 13 includes the fiber array unit of any of Examples 11-12, wherein the photonic crystal fiber has a large mode area and is configured for single mode propagation.

Example 14 includes the fiber array unit of any of Examples 11-13, wherein the photonic crystal fiber comprises a pattern of holes, wherein the pattern of holes corresponds to a photonic stop band for a particular propagation mode.

Example 15 includes the fiber array unit of any of Examples 11-14, wherein: a first end of the mode field adapter fiber has a first mode field diameter (MFD) and a second end of the mode field adapter fiber has a second MFD, wherein the first MFD is larger than the second MFD; the first end of the mode field adapter fiber is coupled to the photonic crystal fiber; and the second end of the mode field adapter fiber is coupled to the single mode fiber.

Example 16 includes the fiber array unit of any of Examples 11-15, wherein the mode field adapter fiber is an adiabatic taper fiber.

Example 17 includes the fiber array unit of any of Examples 11-16, wherein the optical fibers are expanded beam optical fibers.

Example 18 includes the fiber array unit of any of Examples 11-17, further comprising a mechanical transfer (MT) connector, wherein the ferrule is coupled to a first end of the optical fibers, and wherein the MT connector is coupled to a second end of the optical fibers.

Example 19 includes a system, comprising: a photonic integrated circuit (PIC); and a fiber array unit (FAU) optically coupled to the PIC, wherein the FAU comprises a plurality of optical fibers, wherein individual optical fibers comprise a photonic crystal fiber, a mode field adapter fiber, and a single mode fiber, wherein a first end of the mode field adapter fiber is coupled to the photonic crystal fiber, and wherein a second end of the mode field adapter fiber is coupled to the single mode fiber.

Example 20 includes the system of Example 19, further comprising a microlens array coupled to the PIC, wherein the FAU is optically coupled to the PIC via the microlens array.

Example 21 includes the system of any of Examples 19-20, further comprising an integrated circuit (IC) die, wherein the IC die comprises processing circuitry, memory circuitry, storage circuitry, or communication circuitry, and wherein the IC die is to communicate optically via the PIC.

Example 22 includes the system of Example 21, further comprising an integrated circuit (IC) package, wherein the IC package comprises: the IC die; and an optical interface electrically coupled to the IC die, wherein the optical interface comprises the PIC and an electronic integrated circuit (EIC) to control the PIC, wherein the IC die is electrically coupled to the EIC.

Example 23 includes the system of Example 22, further comprising a circuit board, wherein the IC package is electrically coupled to the circuit board.

Example 24 includes the system of any of Examples 19-23, wherein the system is a mobile device, a wearable device, a computer, a server, a video playback device, a video game console, a display device, a camera, or an appliance.

Example 25 includes a method, comprising: forming one or more optical fibers, wherein individual optical fibers comprise a photonic crystal fiber, a mode field adapter fiber, and a single mode fiber, wherein the photonic crystal fiber, the mode field adapter fiber, and the single mode fiber are coupled, and wherein the mode field adapter fiber is between the photonic crystal fiber and the single mode fiber; and attaching the one or more optical fibers to a ferrule.

Example 26 includes the method of Example 25, wherein forming the one or more optical fibers comprises: splicing the photonic crystal fiber with the mode field adapter fiber; and splicing the mode field adapter fiber with the single mode fiber.

Example 27 includes the method of any of Examples 25-26, wherein attaching the one or more optical fibers to the ferrule comprises: assembling the one or more optical fibers in one or more grooves of the ferrule, wherein individual optical fibers are assembled in individual grooves.

Example 28 includes the method of any of Examples 25-27, further comprising plugging the ferrule into an optical coupler.

Example 29 includes the method of Example 28, wherein the optical coupler is optically coupled to a photonic integrated circuit.

1. An optical fiber, comprising:
a first optical fiber section, wherein the first optical fiber section comprises a photonic crystal fiber;
a second optical fiber section coupled to the first optical fiber section, wherein the second optical fiber section comprises a mode field adapter fiber; and
a third optical fiber section coupled to the second optical fiber section, wherein the third optical fiber section comprises a single mode fiber.

2. The optical fiber of claim 1, wherein the second optical fiber section is between the first optical fiber section and the third optical fiber section.

3. The optical fiber of claim 1, wherein the photonic crystal fiber has a large mode area and is configured for single mode propagation.

4. The optical fiber of claim 3, wherein the photonic crystal fiber comprises a pattern of holes, wherein the pattern of holes corresponds to a particular photonic stop band for single mode propagation.

5. The optical fiber of claim 1, wherein a core of the mode field adapter fiber is tapered, wherein a first end of the mode field adapter fiber has a first mode field diameter (MFD), and wherein a second end of the mode field adapter fiber has a second MFD, wherein the first MFD is larger than the second MFD.

6. The optical fiber of claim 5, wherein the first end of the mode field adapter fiber has a large mode area.

7. The optical fiber of claim 5, wherein the first end of the mode field adapter fiber is coupled to the photonic crystal fiber, and wherein the second end of the mode field adapter fiber is coupled to the single mode fiber.

8. The optical fiber of claim 1, wherein the mode field adapter fiber is an adiabatic taper fiber.

9. The optical fiber of claim 1, wherein the single mode fiber is a SMF-28 fiber.

10. The optical fiber of claim 1, wherein the optical fiber is an expanded beam optical fiber.

11. A fiber array unit, comprising:
a ferrule; and
a plurality of optical fibers coupled to the ferrule, wherein individual optical fibers comprise a photonic crystal fiber, a mode field adapter fiber, and a single mode fiber, wherein:
the photonic crystal fiber, the mode field adapter fiber, and the single mode fiber are coupled; and
the mode field adapter fiber is between the photonic crystal fiber and the single mode fiber.

12. The fiber array unit of claim 11, wherein the ferrule comprises a plurality of grooves, wherein individual optical fibers are coupled to individual grooves.

13. The fiber array unit of claim 11, wherein the photonic crystal fiber has a large mode area and is configured for single mode propagation.

14. The fiber array unit of claim 11, wherein the photonic crystal fiber comprises a pattern of holes, wherein the pattern of holes corresponds to a photonic stop band for a particular propagation mode.

15. The fiber array unit of claim 11, wherein:
a first end of the mode field adapter fiber has a first mode field diameter (MFD) and a second end of the mode field adapter fiber has a second MFD, wherein the first MFD is larger than the second MFD;
the first end of the mode field adapter fiber is coupled to the photonic crystal fiber; and
the second end of the mode field adapter fiber is coupled to the single mode fiber.

16. The fiber array unit of claim 11, further comprising a mechanical transfer (MT) connector, wherein the ferrule is coupled to a first end of the optical fibers, and wherein the MT connector is coupled to a second end of the optical fibers.

17. A system, comprising:
a photonic integrated circuit (PIC); and
a fiber array unit (FAU) optically coupled to the PIC, wherein the FAU comprises a plurality of optical fibers, wherein individual optical fibers comprise a photonic crystal fiber, a mode field adapter fiber, and a single mode fiber, wherein a first end of the mode field adapter fiber is coupled to the photonic crystal fiber, and wherein a second end of the mode field adapter fiber is coupled to the single mode fiber.

18. The system of claim 17, further comprising a microlens array coupled to the PIC, wherein the FAU is optically coupled to the PIC via the microlens array.

19. The system of claim 17, further comprising an integrated circuit (IC) die, wherein the IC die comprises processing circuitry, memory circuitry, storage circuitry, or communication circuitry, and wherein the IC die is to communicate optically via the PIC.

20. The system of claim 19, further comprising an integrated circuit (IC) package, wherein the IC package comprises:
the IC die; and
an optical interface electrically coupled to the IC die, wherein the optical interface comprises the PIC and an electronic integrated circuit (EIC) to control the PIC, wherein the IC die is electrically coupled to the EIC.
